(19) United States
(12) Patent Application Publication
(10) Pub. No.: US 2009/0090672 A1
(43) Pub. Date: Apr. 9, 2009

(54) Efficient fluid flow system

(76) Inventor: Clifford C. Jones, Janesville, WI (US)

Correspondence Address: RYAN KROMHOLZ & MANION, S.C., POST OFFICE BOX 26618, MILWAUKEE, WI, 53226, US

(21) Appl. No.: 12/154,805

(22) Filed: May 27, 2008

Related U.S. Application Data
(60) Provisional application No. 60/931,729, filed on May 25, 2007.

(51) Int. Cl. B03C 1/02

(52) U.S. Cl. 210/695; 210/222

(57) ABSTRACT

An assembly for improving the fluid flow through a fluid system and method of using the assembly. The system consists of at least a pair of magnets placed upon the fluid line of the fluid. The magnets are aligned around the fuel line so that the polarities (N-N, S-S) of two mating magnets will be aligned.

### RELATED APPLICATION

This application claims the benefit of co-pending provisional patent application Ser. No. 60/931,729 filed 25 May 2007.

### BACKGROUND OF THE INVENTION

The present invention relates to devices and systems for improving fluid flow through fluid systems and, more particularly, to fluid flow through gasoline, diesel, and other fuel systems.

Fuel consumption is a world-wide concern, especially with its impact on the environment. Furthermore, the increasing cost of gasoline is a major concern. Thus, improvements in the efficiency of fuel systems and the emissions from these fuel systems are of utmost concern.

An adverse effect when improving the fuel efficiency for a fuel system is a reduction in the power delivered by the system. In many instances, such as when hauling heavy materials or pulling other objects, it is not feasible or desirable to lose much power in exchange for improved fuel efficiency. Thus, it would be beneficial to improve fuel efficiency while minimizing power that is lost from the system in exchange.

There are other areas of concern concerning environmental factors that can be addressed by improved fluid flow systems. As an example, treatment processes and filtration systems for water systems are becoming more prominent. More efficient flow of water through these systems is desirable, which will not only improve the quality of water from these systems, but will also use less energy, resulting in a lessening of an environmental impact.

Thus, it would be advantageous to provide systems and methods for improving the flow of fluids through fluid systems, not only in fuel systems, but in other types of fluid flow systems, as well. An improved design would be capable of being used with several fluid flow systems, with minimal adaptation from one system to another.

### SUMMARY OF THE INVENTION

The present invention provides a new and useful system for improving the fluid flow through these systems. The system consists of at least a pair of magnets placed upon the fuel line or fuel lines of the fuel system. The magnets are aligned around the fuel line, with equal number of magnets being placed on the top and bottom of the fuel line.

The magnets are positioned so that the polarities of two mating magnets will be aligned. That is, a top magnet will be aligned with a bottom magnet, with the positive end of one magnet aligned with the positive end of the other magnet and the negative end of one magnet aligned with the negative end of the other magnet. It can also be stated that the north poles of the magnet and the south poles of the magnet are aligned with one another. Because the arrangement of the magnets repels one another, each pair of magnets is then securely secured onto the fuel line with straps or bands.

The arrangement provides for improved fuel efficiency, horsepower and a decrease in emissions from the exhaust. It is also believed that the present arrangement provides improvements in other fluid flow systems, such as in water filtration systems and the like.

### BRIEF DESCRIPTION OF THE DRAWINGS

FIG. 1 is a diagrammatic depiction of magnets demonstrating the attraction of the magnets.

FIG. 2A is a diagrammatic depiction of magnets arranged according to the present invention.

FIG. 2B is a further diagrammatic depiction of magnets arranged according to the present invention.

FIG. 3 is a perspective view of the present invention as it would be mounted on a fuel line of a vehicle.

FIG. 4 is a further perspective view of the present invention mounted on a fuel line of a vehicle, near the engine block.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention provides a new and novel concept for improving the fluid flow through fluid lines, most importantly fuel lines, especially fuel lines used within motor vehicles. The present invention utilizes magnets and magnetized materials to affect the flow of fluid through the fluid lines, which leads to improved qualities for the fluid in the lines. The improved qualities translate to overall improvements of the fuel system, such as increased gas mileage for a vehicle, increased horsepower for the vehicles, and a reduction in emissions for the vehicle.

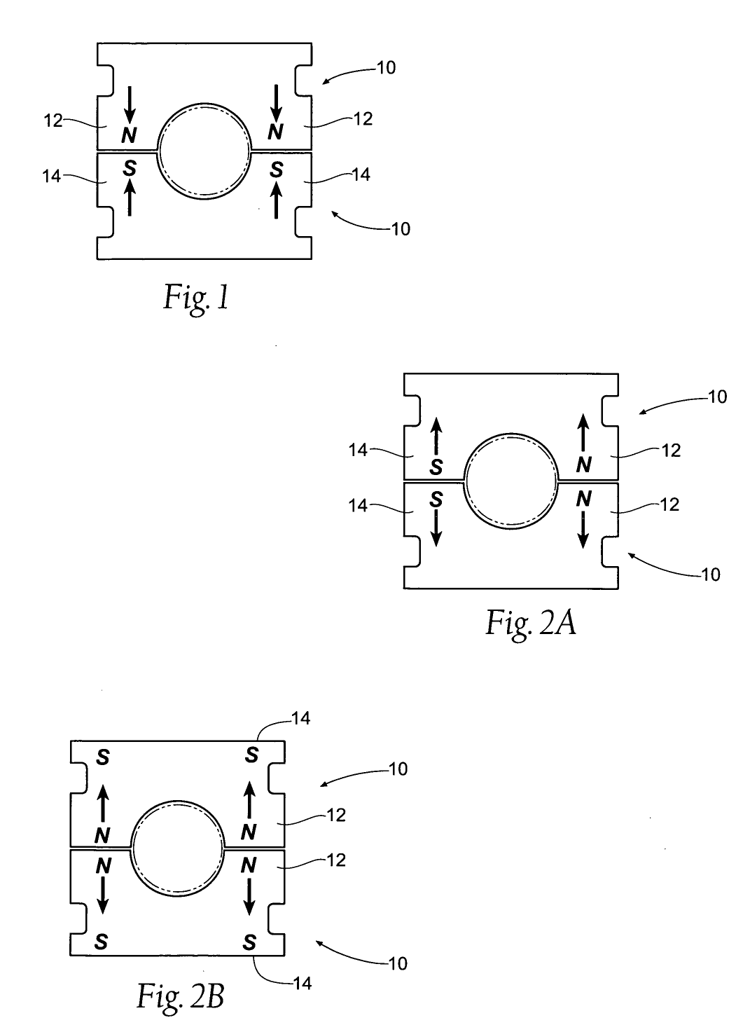

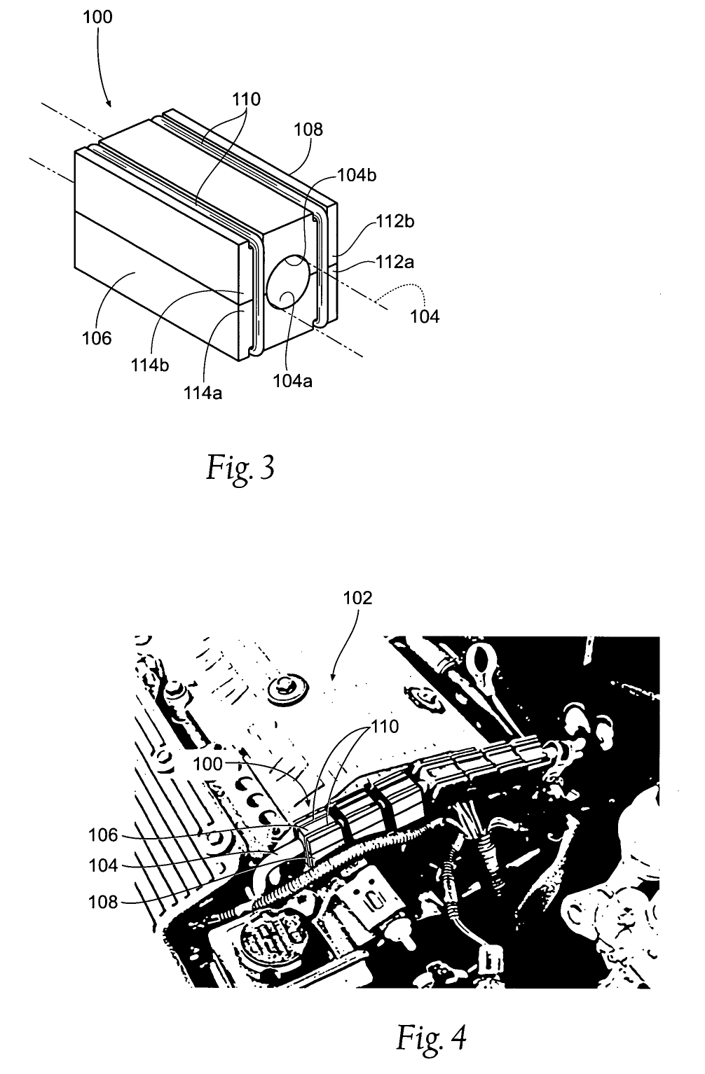

FIG. 1 depicts the general attraction of magnets 10, as they would typically be attracted to one another. FIGS. 2A and 2B show the magnets 10, as they would be arranged according to the present invention. The magnets 10 of the present invention preferably have a generally half circle shape or C-shape so that they will completely surround a fuel line, as demonstrated in FIGS. 3 and 4. Each magnet 10 has a north end or polarity 12 and a south end or polarity 14, also commonly referred to as the positive end and the negative end of the magnet 10. As is commonly known, magnets are attracted to each other when their opposing polarities are in contact with one another, and magnets repel one another when the same polarities are near one another. That is, magnets will attract one another when the north end 12 is near the south end 14, as is shown in FIG. 1, and the magnets will repel one another, as is shown in the FIGS. 2A and 2B. The present invention utilizes the principles demonstrated by FIGS. 2A and 2B, that similar polarities of magnets will repel one another.

FIG. 3 depicts an assembly 100 according to the present invention. The assembly 100 is supported by a fuel line 104 (shown in phantom) and is designed to improve the quality of the fluid flowing through the fuel line 104. The assembly comprises a pair of mating magnets 106, 108. Each of the magnets 106, 108 is positioned on a respective side 104a, 104b of the fuel line. It is understood that sides 104a, 104b should not limit the placement of the magnets 106, 108 to any specific arrangement around the fuel line 104. The magnets 106, 108 are secured to one another with securing means 110, which are preferably elastic straps or bands, such as sturdy rubber band, but can be any suitable devices or means that will sufficiently secure the magnets 106, 108 to one another. Likewise, the securing means 110 could releasably or permanently join the magnets 106, 108 to one another. Preferably the magnets 106, 108 are secured to one another so that the magnets 106, 108 completely surround the fuel line 104.

Still referring to FIG. 3, the magnet 106 has a north end 112a having a positive polarity and south end 114a having a negative polarity. The magnet 108 also has a north end 112b having a positive polarity and south end 114b having a negative polarity. The arrangement is believed to increase the percentage of burnable oxygen within the fluid, which means more efficient used of the fluid in the fluid lines. As is shown, the positive polarities 112a and 112b are aligned with one another, as are the negative polarities 114a and 114b. Because the magnets 106, 108 will repel one another, the securing means 110 holds the magnets 106, 108 in contact with one another so that the magnets 106, 108 surround the fuel line 104. As such, the securing means 110 should be of sufficient strength so that the magnets will be in tight relationship with one another, even though the natural tendency of the magnets 106 and 108 is to force themselves away from one another.

FIG. 4 shows the fluid flow assembly 100 of the present invention in connection with an engine 102 of a motor vehicle. The assembly 100 is supported by the fuel line 104 and, as stated above, is designed to improve the quality of the fluid flowing through the fuel line 104. The assembly 100 comprises a plurality of first magnets 106 and a plurality of mating second magnets. The assembly 100 has at least one pair of mating magnets 106, 108, and may have any number of pairs of magnets 106, 108 as desired. The magnets 106, 108 will be arranged as depicted in FIG. 3, with like polarities secured against one another.

The arrangement of having like polarities of each of the pair of magnets 106, 108 in direct contact leads to the improved qualities of the invention, such as improved gas mileage, lower emissions, and improved horsepower for the vehicle. It is understood that the amount of improvement for each of these qualities will be determined on the type of engine, number or cylinders in the engine driving conditions, and other variables. The assembly 100 can be placed on any position on any fuel line and it is believed to provide improved qualities, provided the assembly 100 is positioned as described. Likewise, the present invention can incorporate any number of magnets and, also, any types of magnets.

The present invention can be used in conjunction with all types of motors and engines, such as internal combustion engines and diesel engines. Further, the present invention can be used in connection with other fluid flow systems and not just in connection with vehicles. For instance, the assembly 100 could be used to provide improve fluid flow qualities through filtration systems, such as water treatment systems. It is believed that the present invention will provide improved qualities for any fluid flow system. That is, the present invention affects the fluid flow through fluid lines in such a manner to increase the productivity of the overall system with which the fluid and the fluid lines area used.

As shown, the magnets used in the present invention are preferably of a C-shape or of a half-circle shape, so that the magnets will completely surround the fuel line. However, it is understood that any shape of magnets could fall within the scope of the present invention. Provided that the magnets are provided so that the like polarities of the magnets can be arranged so that they are in close proximity to one another, and preferably that the magnets completely encircle the fuel line, the magnets would fall within the scope of the present invention.

The present invention provides an inventive assembly and method of improving fluid flow that had not previously been contemplated by the prior art. The use of magnets according to the present invention is counterintuitive to what was previously taught, with the prior art showing and teaching arrangements that used magnets where the principles of the arrangements were based on the magnets capable of being attracted to one another. The forced mating or fixation of the like polarities a pair of magnets according to the present invention provides a novel system.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An assembly for increasing the efficiency of fluid flow within a fluid line, said assembly comprising:
a first magnet having a positive polarity and a negative polarity, said first magnet being positioned on a first side of said fluid line;
a second magnet having a positive polarity and a negative polarity, said second magnet being positioned on a second side of said fluid line;
means for securing said first magnet to said second magnet around said fluid line, wherein said positive polarity of said first and said second magnets being aligned with one another, and said negative polarity of said first and said second magnets being aligned with one another.

2. The assembly according to claim 1, wherein said securing means comprises a flexible rubber material.

3. The assembly according to claim 1, wherein at least one of said magnets comprises a generally C-shape.

4. The assembly according to claim 3, wherein both magnets comprise a generally C-shape.

5. An assembly for increasing the efficiency of gas flow within a gas line for use on a motor vehicle, said assembly comprising:
a plurality of first magnets, each of said first magnets having a positive polarity and a negative polarity, each of said first magnets being positioned on a first side of said fluid line;
a plurality of second magnets, each of said magnets having a positive polarity and a negative polarity, said second magnets being positioned on a second side of said fluid line;
means for securing one of said first magnets to a respective one of said second magnets around said fluid line, wherein said positive polarity of said first and said second magnets being aligned with one another, and said negative polarity of said first and said second magnets being aligned with one another.

6. The assembly according to claim 1, wherein said securing means comprises a flexible rubber material.

7. The assembly according to claim 1, wherein at least one of said first and said second magnets of a respective pair of first and said second magnets comprises a generally C-shape.

8. The assembly according to claim 3, wherein both magnets of a respective pair of first and said second magnet comprise a generally C-shape.

9. A method of improving the fuel efficiency through a fuel line of a motor vehicle, the method consisting of the steps of:
providing a fuel line;
providing a first magnet having a positive polarity and a negative polarity, said first magnet being positioned on a first side of said fluid line;
providing a second magnet having a positive polarity and a negative polarity, said second magnet being positioned on a second side of said fluid line; and
securing said first magnet to said second magnet around said fluid line so that said positive polarity of said first and said second magnets are aligned with one another, and said negative polarity of said first and said second magnets are aligned with one another.

10. The method of claim 9 further comprises the steps of:
providing a plurality of first magnets, each of said first magnets having a positive polarity and a negative polarity, each of said first magnets being positioned on a first side of said fluid line;
providing a plurality of second magnets, each of said magnets having a positive polarity and a negative polarity, said second magnets being positioned on a second side of said fluid line; and
securing one of said first magnets to a respective one of said second magnets around said fluid line, wherein said positive polarity of said first and said second magnets being aligned with one another, and said negative polarity of said first and said second magnets being aligned with one another.

11. The method of claim 9 wherein said step of securing said magnets to one another comprises using a rubber band to secure said magnets to one another.

12. The method of claim 9 wherein one of said first and said second magnets generally comprises a C-shape.

13. The method of claim 9, wherein both of said first and said magnets generally comprises a C-shape.
